(19) United States
(12) Patent Application Publication
(10) Pub. No.: US 2011/0155684 A1
(43) Pub. Date: Jun. 30, 2011

(54) BABY BOTTLE AND FEEDING SYSTEM

(76) Inventor: Craig Sirota, Lake Forest, IL (US)

(21) Appl. No.: 12/977,886

(22) Filed: Dec. 23, 2010

Related U.S. Application Data
(63) Continuation-in-part of application No. 29/354,516, filed on Jan. 25, 2010.
Application No. 29/354,516 is a continuation-in-part of application No. 29/340,790, filed on Jul. 24, 2009, now Pat. No. D627895.
Application No. 29/340,790 is a continuation-in-part of application No. 29/354,515, filed on Jan. 25, 2010.
Application No. 29/354,515 is a continuation-in-part of application No. 29/340,789, filed on Jul. 24, 2009, now Pat. No. D627894.
Application No. 29/340,789 is a continuation-in-part of application No. 29/365,042, filed on Jul. 1, 2010.
Application No. 29/365,042 is a continuation-in-part of application No. 29/365,047, filed on Jul. 1, 2010.
Application No. 29/365,047 is a continuation-in-part of application No. 29/365,049, filed on Jul. 1, 2010.

(51) Int. Cl. A61J 11/02

(52) U.S. Cl. 215/11.5

(57) ABSTRACT

A vented baby bottle assembly and a baby feeding system having a plurality of vented baby bottle assemblies is provided. The baby bottle assembly includes a bottle with at least one venting notch in the mouth of the bottle, and an artificial feeding nipple fastened thereto. When the feeding nipple is fastened to the mouth of the bottle, a sealing region on the feeding nipple forms one or more, one-way, negative-pressure, relief valves at the location of the venting notch(es) for allowing air to enter the bottle when suction is applied to the nipple-tip by a child. The feeding system includes a plurality of stages with a separate bottle assembly corresponding to each successive stage. At each successive stage, the volume of the bottle in the assembly is equal to or greater than the bottle from the assembly in the preceding stage. In addition, at each successive stage, the artificial feeding nipple is generally longer, less flexible, harder and has a larger feeding orifice than the feeding nipple from the previous stage.

### CROSS-REFERENCE TO RELATED APPLICATIONS

This application is a continuation-in-part (CIP) of, and claims priority to:

U.S. Design patent application Ser. No. 29/354,516 filed Jan. 25, 2010, which is a CIP of U.S. Design patent application Ser. No. 29/340,790 (U.S. D627,895) filed Jul. 24, 2009;
U.S. Design patent application Ser. No. 29/354,515 filed Jan. 25, 2010, which claims priority to U.S. Design patent application Ser. No. 29/340,789 (U.S. D627,894) filed Jul. 24, 2009;
U.S. Design patent application Ser. No. 29/365,042 filed Jul. 1, 2010;
U.S. Design patent application Ser. No. 29/365,047 filed Jul. 1, 2010; and
U.S. Design patent application Ser. No. 29/365,049 filed Jul. 1, 2010;
the entire contents of each of which is hereby incorporated by reference herein.

### FIELD

This disclosure relates to baby bottles and baby feeding systems.

### BACKGROUND

Closed baby bottles with flexible feeding nipples are commonly used to feed milk, baby formula, pediatric solutions, juice, and other liquids to hungry infants, babies and children. However, as is fairly common, when the child feeds and applies suction to the nipple in order to withdraw the feeding fluid from within the baby bottle, a partial vacuum is formed within the baby bottle assembly. To alleviate the pressure differential between the outside air and the partial vacuum in the baby bottle, often the child must stop feeding to allow air to re-enter the bottle through the nipple's feeding orifice. To address this problem, baby bottles have been developed that provide for venting during feeding, whereby a vent is located either on the bottle itself or at some location in the nipple, which allows air to re-enter the bottle through the vent while the child is feeding. However, many of the vented bottles that have been developed to date provide venting that is too close to the feeding orifice, which can allow air to mix with the fluid ingested by the child, leading to increased chances of gas, colic, and the child spitting up. Furthermore, many of the vents developed to date can begin to leak over time, allowing fluid to leak out of the bottle when the bottle is inverted to begin feeding. Accordingly, there is a need for a baby bottle having a vent located away from the feeding orifice, and a vent that will not leak over time.

In addition, when a breastfed baby is transitioning to bottle feeding and is given an artificial feeding nipple for the first time, or when both breast feeding and bottle feeding are used regularly to feed a child, “nipple confusion” can result. This is a situation in which the baby may not take the artificial feeding nipple because (1) artificial feeding nipples often cannot effectively simulate a mother's actual breast and nipple, and (2) the feeding methods/techniques necessary for effective breast feeding, and those necessary for effective bottle feeding, require completely different mouth and tongue motions and swallowing skills of the child. Breastfeeding requires a combination of suction and peristaltic pumping motion to pump milk from the breast, whereas bottle feeding generally requires only the application of suction to the artificial feeding nipple to remove fluid from the bottle. Two separate feeding methods can be confusing for a baby and often results in the baby refusing to take either the mother's breast or the artificial feeding nipple, and sometimes both. Furthermore, the feeding techniques of a child change as the child gets older and stronger. Accordingly, there is a need for an artificial feeding nipple that more closely simulates that of a mother's natural breast and nipple, to allow for a smoother transition from breastfeeding to bottle feeding. There is also a further need for a bottle feeding system that can accommodate the changing feeding techniques of the child as he gets older, and still more closely simulate the feeding methods/techniques associated with breast feeding.

### SUMMARY

Described herein is a baby bottle assembly that includes a bottle for holding a feeding substance with at least one air venting notch disposed in the mouth of the bottle, and an artificial feeding nipple fastened to the mouth of the bottle, wherein a sealing portion of the artificial feeding nipple forms a liquid tight seal with the mouth of the bottle and forms one or more, one-way, negative-pressure, relief valves at the location of the venting notch(es). In additional embodiments, the baby bottle assembly includes a neck ring, into which the artificial feeding nipple is inserted and seated, that is secured to the neck of the bottle for fastening the artificial feeding nipple to the mouth of the bottle. In additional embodiments, the baby bottle assembly includes a cap that can be secured over the artificial feeding nipple to keep the feeding nipple clean when it is not in use.

Further described herein is a baby feeding system that includes a plurality of baby bottle assemblies as disclosed herein and a plurality of stages that correspond to the natural feeding stages of a child as he grows from a newborn to a toddler. Each stage has associated therewith a separate baby bottle assembly that has different physical characteristics than the other bottle assemblies in the other stages. Generally, at each successive stage, the bottle in the assembly has an equal or greater volume than the bottle in the previous stage. In addition, at each successive stage, the artificial feeding nipple is generally longer, less flexible, and harder than the artificial feeding nipple in the previous stage. Lastly, at each successive stage, the feeding orifice is generally larger than the feeding orifice in the previous stage.

Other embodiments, objects, features and advantages will be set forth in the detailed description of the embodiments that follows, and in part will be apparent from the description, or may be learned by practice, of the claimed invention. These objects and advantages will be realized and attained by the processes and compositions particularly pointed out in the written description and claims hereof. The foregoing Summary has been made with the understanding that it is to be considered as a brief and general synopsis of some of the embodiments disclosed herein, is provided solely for the benefit and convenience of the reader, and is not intended to limit in any manner the scope, or range of equivalents, to which the appended claims are lawfully entitled.

### BRIEF DESCRIPTION OF THE DRAWINGS

The present invention is described in detail below with reference to the attached drawing figures, wherein:

FIG. 1 is an exploded side view of an embodiment of a baby bottle assembly of the present disclosure;

FIG. 2 is a an exploded perspective view of an alternate embodiment of a baby bottle assembly of the present disclosure;

FIG. 3 is a side cross-sectional view of an embodiment of an assembled baby bottle assembly (without the cap) of FIG. 1;

FIG. 4 is isometric view of an embodiment of a bottle of the baby bottle assembly of FIG. 1;

FIG. 5 is isometric view of an alternate embodiment of a bottle of the baby bottle assembly of FIG. 2;

FIG. 6 is a side view of an embodiment of an artificial feeding nipple of the baby bottle assembly of FIG. 1;

FIG. 7 is a side cross-sectional view of an embodiment of an artificial feeding nipple of FIG. 6;

FIG. 8 is a side cross-sectional view of an embodiment of a neck ring and cap of the baby bottle assembly of FIG. 1;

FIG. 9 is a side cross-sectional view of an alternate embodiment of a neck ring and cap of the baby bottle assembly of FIG. 2

FIG. 10 is a side view of an embodiment of a feeding system of the present disclosure that includes three separate stages;

### DETAILED DESCRIPTION

While the present invention is capable of being embodied in various forms, the description below of several embodiments is made with the understanding that the present disclosure is to be considered as an exemplification of the claimed subject matter, and is not intended to limit the appended claims to the specific embodiments described herein. The headings used throughout this disclosure are provided for convenience only and are not to be construed to limit the claims in any way. The various embodiments disclosed herein may be combined with other embodiments for the creation and description of yet additional embodiments.

### Bottle Assembly and Function

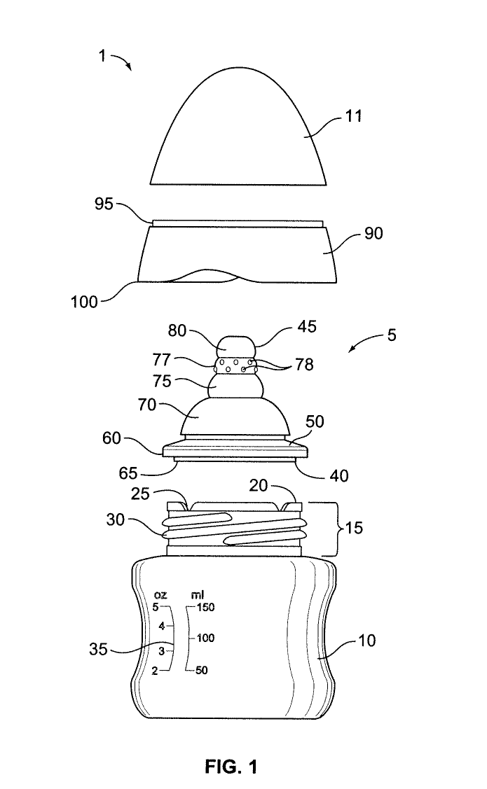

FIG. 1 depicts a baby bottle assembly 1 for feeding a young child. The target child can range in age from a newborn to a toddler, or any similar age range where the child has not yet mastered the skill of drinking from a standard cup. The baby bottle assembly 1 includes an artificial feeding nipple 5 fastened to a bottle 10 by a neck ring 90. The baby bottle assembly may also optionally include a cap 11 that is secured to the neck ring.

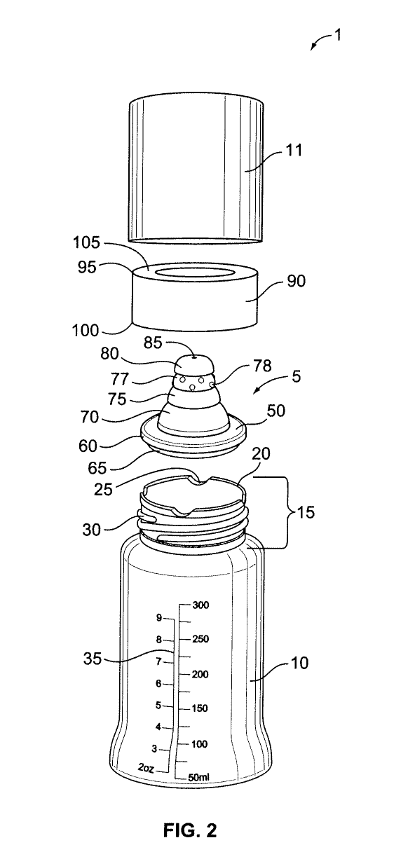

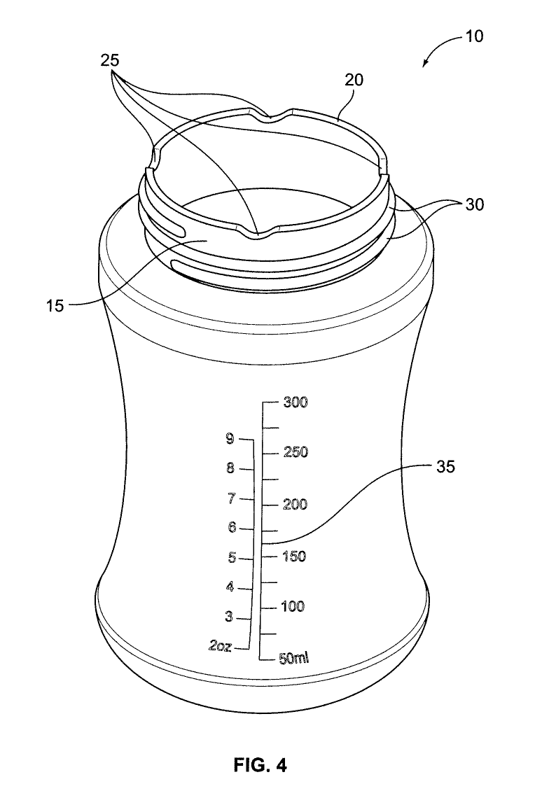

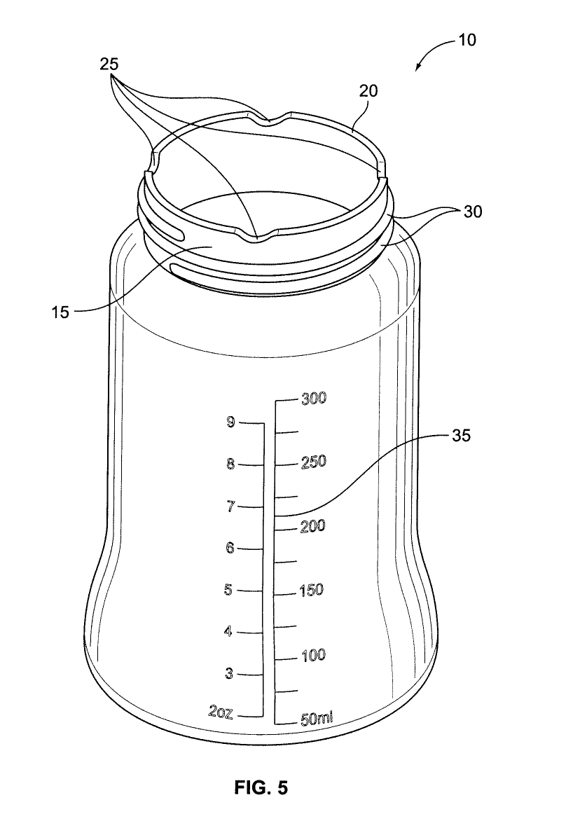

Referring to FIGS. 1-5, the bottle 10 is a container having a base with an outer periphery and closed sidewalls (or a closed sidewall) connected to the outer periphery of the base and extending upward therefrom. The bottle 10 further includes a neck 15 disposed at, and extending upward form, the top of the closed sidewalls of the bottle 10. The bottle 10 also includes a mouth 20 that is substantially open and is disposed at a top end of the neck 15 of the bottle 10. The bottle 10 is configured to hold a liquid such as, for example, water, milk, baby formula, or other similar liquid that can be poured into the bottle 10 through the mouth 20.

The bottle 10 further includes at least one air venting notch 25 disposed in the periphery of the mouth 20 of the bottle 10. In an alternate embodiment, the bottle 10 includes a plurality of air venting notches 25 disposed in the periphery of the mouth 20 of the bottle 10. The bottle further includes a fastener disposed on the neck 15 of the bottle 10 for mating with a complimentary fastener disposed on the neck ring 90. The bottle further includes a series of graduated volume markings 35 disposed on the sidewall of the bottle 10, for indicating the volume of fluid contained in the bottle 10 at any given time.

In one embodiment, the bottle 10, the neck 15, and the mouth 20, are each generally cylindrical and have a circular top cross-sectional shape. However, the disclosure of this embodiment should not be read to limit the shape of the bottle 10, the neck 15, or the mouth 20. Rather, in alternate embodiments the bottle 10, the neck 15, and the mouth 20 may have alternate top cross-sectional shapes, such as, for example, square or other polygonal shapes.

The bottle 10 may be made of glass, plastic, or any other suitable composite or polymer, depending on the durability, flexibility, safety, and/or health requirements desired in the bottle 10. Furthermore, the bottle 10 may be clear, translucent, or opaque, and may also be made of a colored or colorless material, depending on the requirements desired in the bottle 10. In one embodiment, the bottle is made from a clear polymer, such as for example polypropylene, that is Bisphenol-A free (“BPA-free”), which allows the user to readily see the level of the fluid contained in the bottle 10 by the graduated volume markings 35, and eliminates the possibility of any health or safety issues associated with polymers containing BPA.

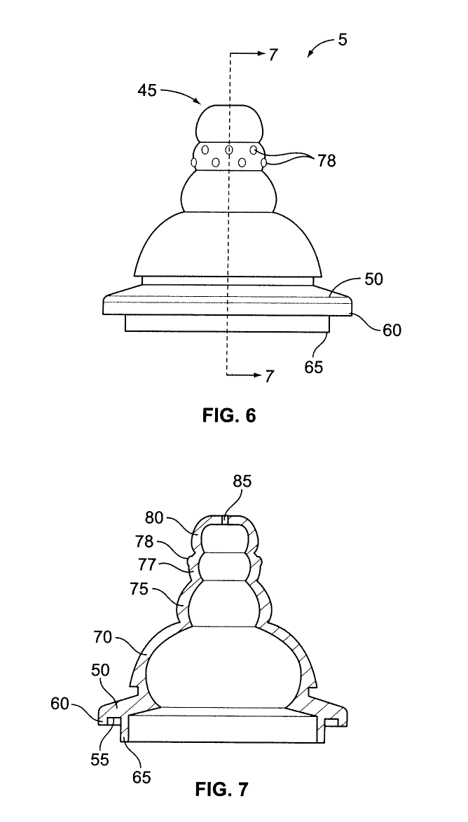

Referring to FIGS. 1-3, 6, and 7, the artificial feeding nipple 5 includes a lower end 40 and an upper end 45. At the lower end 40, the artificial feeding nipple 5 includes a sealing portion 50 having a horizontal gasket 55, an outer skirt 60 extending downward from an outer edge of the gasket 55, and a flexible sealing ring 65 extending downward from an inner edge of the gasket 55. The sealing portion 50 is configured so that the gasket 55 will form a liquid and air tight seal with the portions of the mouth 20 of the bottle 10 with which it comes in contact.

The artificial feeding nipple 5 also includes a hollow base 70 attached at its lower outer periphery to, and extending generally upward from, the sealing portion 50. In one embodiment, the hollow base 70 is domed and simulates the fatty tissue that surrounds the areola in a woman's breast. The artificial feeding nipple 5 further includes a hollow areola region 75 connected at its lower end to an upper end of the hollow base 70. Furthermore, the artificial feeding nipple 5 also includes a nipple-base 77 connected, at its lower end, to an upper end of the areola region 75. Lastly, the artificial feeding nipple 5 further includes a nipple-tip 80 that is connected, at its lower end, to an upper end of the nipple-base 77. The nipple-tip 80 includes a substantially closed domed upper end.

In one embodiment, the areola region 75 of the artificial feeding nipple 5 has an outer surface texturing disposed thereon that serves to differentiate the areola region 75 from the softer, hollow base 70, and simulates the differences between the tissue of the areola and that of the softer fatty breast tissue surrounding the areola. In addition, the nipple-base 77 has disposed thereon a plurality of raised surface bumps 79 that simulate the hardened “teething” surface that naturally develops at the base of a woman's nipple due to repeated breast feeding. In alternate embodiments, the nipple-base 77 may be absent, with only an areola region 75 disposed between the hollow base 70 and the nipple-tip 80. In additional alternate embodiments, there may be only a hollow base 70 connected directly to the nipple-tip 80.

Disposed in the top end of the nipple-tip 80 is at least one feeding orifice 85 through which feeding liquids may pass. The artificial feeding nipple 5 is a structure that is hollow from its lower end 40 to its upper end 45, and through which fluid will flow from the bottle 10 and out through the feeding orifice 85.

In one embodiment, the feeding orifice 85 disposed in the nipple-tip 80 is generally a small diameter, circular cylindrical hole. However, in alternate embodiments, the orifice may have alternate shapes and varying dimensions that allow the feeding fluid to flow through the artificial feeding nipple 5 upon the application of suction or peristaltic action, depending on the desired flow rate, the viscosity and texture of the material to be fed from the bottle assembly 1 to the child, and other flow characteristics desired. For example, in alternate embodiments, the feeding orifice 85 may be a plurality of cylindrical holes or perforations, an I-shaped single slit, Y-shaped triple slit, X-Shaped quadruple slit, or other orifice shapes that act like a valve for feeding children who can handle larger flow rates or thicker feeding fluids, such as liquid cereal feeding.

In one embodiment, the artificial feeding nipple 5 and the sealing portion 50 thereof have a generally circular, top cross-sectional shape. However, the disclosure of this embodiment should not be read to limit the shape of the artificial feeding nipple 5 and sealing portion 50, rather the sealing portion 50 of the feeding nipple 5 is shaped to accommodate and compliment the shape of the neck 15 and the mouth 20 of the bottle 10. As such, in alternate embodiments the mouth 20 of the bottle 10 and the sealing portion 50 of the feeding nipple 5 can have alternate top profiles such as square or any other polygonal shape as desired.

The artificial feeding nipple 5 may be made of silicone, latex, rubber, or any other suitable composite or polymer, depending on the durability, flexibility, safety, and/or health requirements desired in the nipple 5. Furthermore, the nipple 5 may be clear, translucent, or opaque, and may also be made of a colored or colorless material, depending on the requirements desired in the nipple 5. In one embodiment, the nipple 5 is made from a clear, food grade, silicone, which is both safe for the child that is feeding and allows the user to readily see through the nipple to the liquid food contents passing through it.

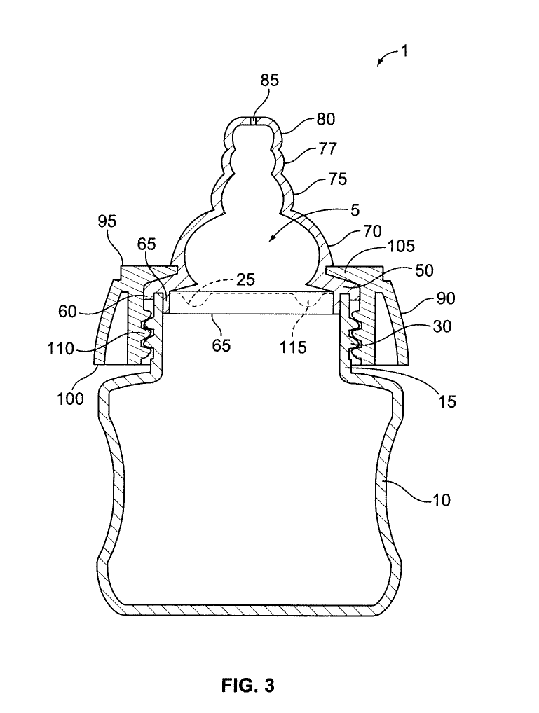

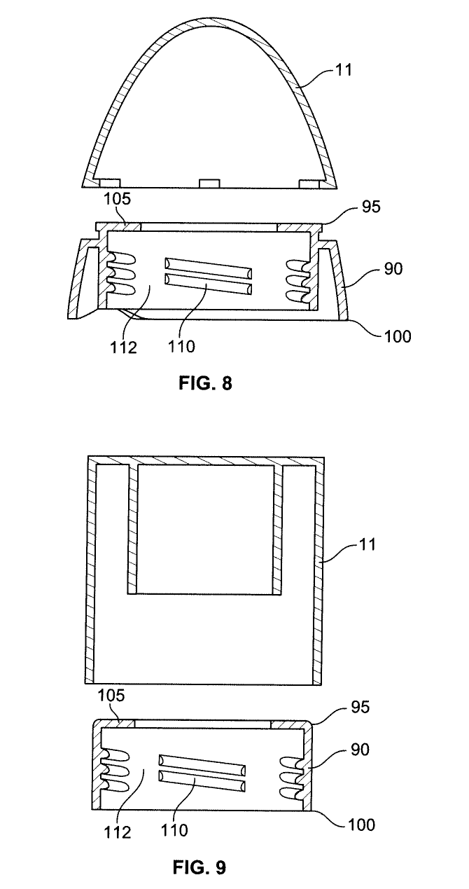

Referring to FIGS. 1-3, 8, and 9, the neck ring 90 is a collar that fastens to the neck 15 of the bottle 10 for securing the artificial feeding nipple 5 to the open mouth 20 of the bottle 10. In one embodiment, the neck ring 90 is a separate, cylindrical collar having an open top end 95, an open bottom end 100, an inward facing flange 105 at the open top end 95 of the neck ring 90, and internal, interrupted-threads 110 in the inner surface of the cylindrical collar of the neck ring 90 for fastening the neck ring 90 to the neck 15 of the bottle 10. The interrupted-threads 110 are one or more individual, non-continuous helical threads on the neck ring 90 that have breaks therein defining air flow channels 112 to allow air to flow therethrough. In this embodiment, the artificial feeding nipple 5 is inserted into the neck ring 90 such that the majority of the artificial feeding nipple 5 protrudes through the top of the neck ring 90, with a top of the sealing portion 50 of the feeding nipple 5 being seated against an inner surface of the inward facing flange 105 of the neck ring 90 (see FIG. 3). The outer diameter of the feeding nipple's sealing portion 50 is larger than the diameter of the opening created by the inward facing flange 105 of the neck ring 90, thus preventing the artificial feeding nipple 5 from passing completely through the neck ring 90.

While the neck ring 90 of the previous embodiment has a circular top cross-sectional shape, the disclosure of this embodiment should not be read to limit the shape of the neck ring 90. In alternate embodiments, the neck ring 90 may have alternate top cross-sectional shapes as needed to compliment the shape of the neck 15 and mouth 20 of the bottle 10, and the sealing portion 50 of the artificial feeding nipple 5.

Furthermore, while the neck ring 90 of the previous embodiment is a separate, removable component of the baby bottle assembly 1, the disclosure of this embodiment should not be read to limit the neck ring 90 to being a separate component. In alternate embodiments, the neck ring 90 and the artificial feeding nipple 5 can be a single integrated piece. In yet another alternate embodiment, the bottle 10, the artificial feeding nipple 5, and the neck ring 90 may all be a single integrated unit, wherein the combined neck ring 90 and artificial feeding nipple 5 are connected to the bottle 10 by an integral living hinge.

In addition, while the previous embodiments disclosed internal interrupted-threads 110 on the neck ring 90 for mating with the external threads disposed on the neck 5 of the bottle 10, in order to fasten the neck ring 90 to the bottle 10, the disclosure of these previous embodiments should not be read to limit the fastening method to a threaded connection. In alternate embodiments, the neck ring 90 may be fastened to the neck 5 of the bottle by a bayonet style connection, a plurality of latches and mating catches, snaps and mating lugs, or other similar mechanical fastening methods as desired or required.

Referring to FIGS. 1-3, in operation, the baby bottle assembly 1 is assembled and functions as follows. The bottle is filled to a desired level with an appropriate feeding fluid. In one embodiment, the upper end 45 of the artificial feeding nipple 5 is inserted into the bottom end 100 of the neck ring 90, such that the upper end 45 of the nipple 5 passes through and protrudes above the top open end 95 of the neck ring 90, and the sealing portion 50 of the nipple 5 seats against the inward facing flange 105 of the neck ring 90, as previously disclosed. The mated feeding nipple 5 and neck ring 90 are then fastened to the neck 15 of the bottle 10 by screwing the internal interrupted-threads 110 of the neck ring 90 to the external threads 30 on the neck 15 of the bottle 10.

When the combined artificial feeding nipple 5 and neck ring 90 are screwed to the neck 15 of the bottle 10, the flexible sealing ring 65 of the sealing portion 50 of the nipple 5 enters the mouth 20 of the bottle and an outer surface of the sealing ring 65 is seated against an inner surface of the neck 15. When the neck ring 90 is fully fastened to the neck 15 of the bottle 10, the bottom edge of the sealing ring 65 sits below the bottom of the air venting notches 25 located in the periphery of the mouth 20 and neck 15 of the bottle 10, with the sealing ring 65 completely covering the venting notches 25 at the inner surface of the neck 15, thus forming a substantially liquid tight seal between the inner surface of the neck 15 and the flexible sealing ring 65. The liquid tight seal between the inner surface of the neck 15 and the sealing ring 65 thus forms a plurality of one-way, negative-pressure, relief valves 115 at the locations of the venting notches 25, which allow air to flow into the bottle through the air venting notches 25, but do not allow liquid to escape out of the bottle therethrough. The inner surface of the neck 15 acts as a valve seat and the sealing ring 65 acts as the moveable valve heads.

Furthermore, when the neck ring 90 is screwed to the neck 15 of the bottle 10, the outer skirt 60 passes over an outer surface of the neck 15 and mouth 20 of the bottle, while the inward facing flange 105 of the neck ring 90 compresses the gasket 55 of the sealing portion 50 against the mouth 20 of the bottle. When the combined feeding nipple 5 and neck ring 90 are fully fastened to the neck 15 of the bottle 10, the compressed gasket 55 creates a substantially liquid and air tight seal with the portions of the bottle mouth 20 located between the air venting notches 25, which are in contact with the gasket 55.

When the bottle 10 is filled with the desired feeding fluid and the baby bottle assembly 1 is fully assembled, the nipple-tip 80 is inserted into the mouth of the child that is to be fed. If the child to be fed is an untrained newborn, the child will first latch on to the nipple-tip 80 with his tongue and begin to suck and pull at the nipple-tip 80. This will cause the child to next draw the nipple-base 77 into his mouth where he can then latch on to the nipple-base 77 and surface bumps 78 with his tongue and continue to suck and pull at both of these sections of the artificial feeding nipple 5. Finally, through continued sucking, the child will then draw the areola region 75 into his mouth while continuing to suck and pull at all three sections of the feeding nipple 5.

In one embodiment disclosed herein, while the artificial feeding nipple 5 is generally a “bulb” shaped nipple, it has enough flexibility that, when in use, it can take the shape of, and function like, an orthodontic (“ortho”) artificial feeding nipple. When the child is pumping and sucking at the various sections of the artificial feeding nipple 5, the nipple 5 will naturally flatten on at least the side adjacent to the roof of the child's mouth, which is a shape that is a common feature of many ortho nipples, and generally conform to the shape of the child's mouth during feeding. The flattened nipple shape accommodates the roof of the child's mouth and simulates the shape of a real breast during nursing. In this manner, when in use, the artificial feeding nipple 5 is also an ortho feeding nipple that more closely simulates the shape of a real breast in the feeding child's mouth and aids in proper oral development during feeding. The natural modification in nipple shape makes the experience of bottle feeding as close to natural breastfeeding as possible. The shape and flexibility of the artificial feeding nipple 5 also allows the child to use a more natural peristaltic pumping/sucking motion to start the flow of liquid feeding fluid from within the bottle 10, through the artificial feeding nipple 5, out the feeding orifice 85, and into the child's mouth for ingesting. In this manner, the artificial feeding nipple 5 is also a peristaltic feeding nipple.

In addition, referring to FIG. 3, when the child begins sucking on the various sections of the nipple 5 and withdrawing feeding fluid from within the bottle assembly 1, the pressure inside the bottle assembly 1 drops below that of the outer atmospheric pressure. When the pressure inside the baby bottle assembly 1 drops to a predetermined value, the higher air pressure outside of the baby bottle assembly 1 forces the flexible sealing ring 65, which acts as a valve head for the one-way relief valves 115, to deflect inward toward the interior of the bottle assembly 1 and allow outside air to draw upward through the air flow channels 112 in the neck ring 90, through the one-way valves 115 (formed by the sealing ring 65 being seated against the inner surface of the neck 15 and completely covering the venting notches 25), and enter into the bottle assembly 1 to relieve the pressure drop. In this manner, the baby bottle assembly 1 of the present disclosure is a vented baby bottle assembly, which allows a child to continuously feed without having to stop to allow air to enter back into the bottle assembly through the feeding orifice, in order to relieve the pressure drop created by the feeding child.

### Feeding System

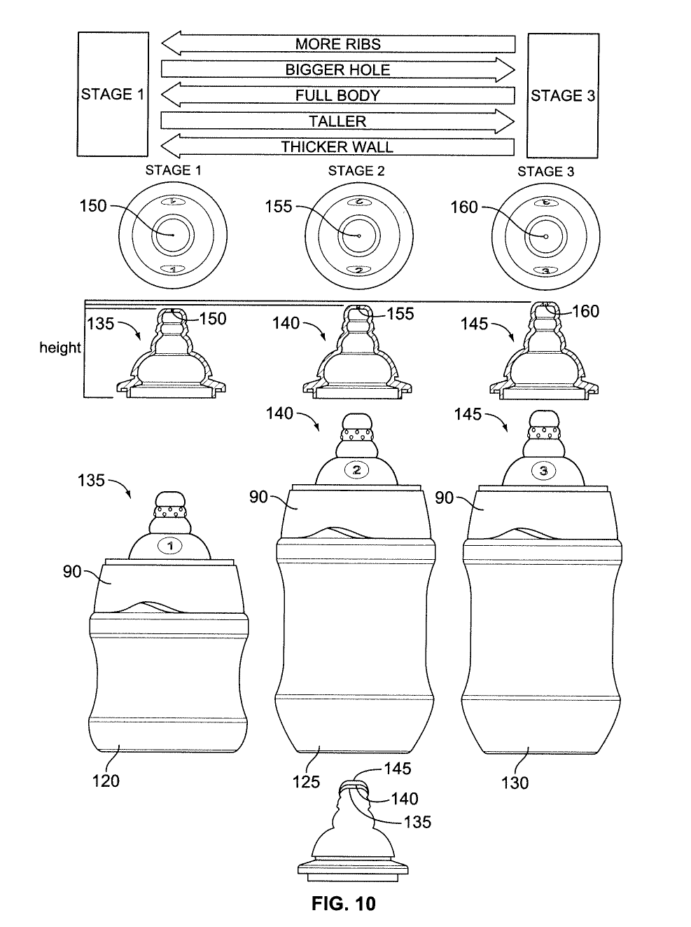

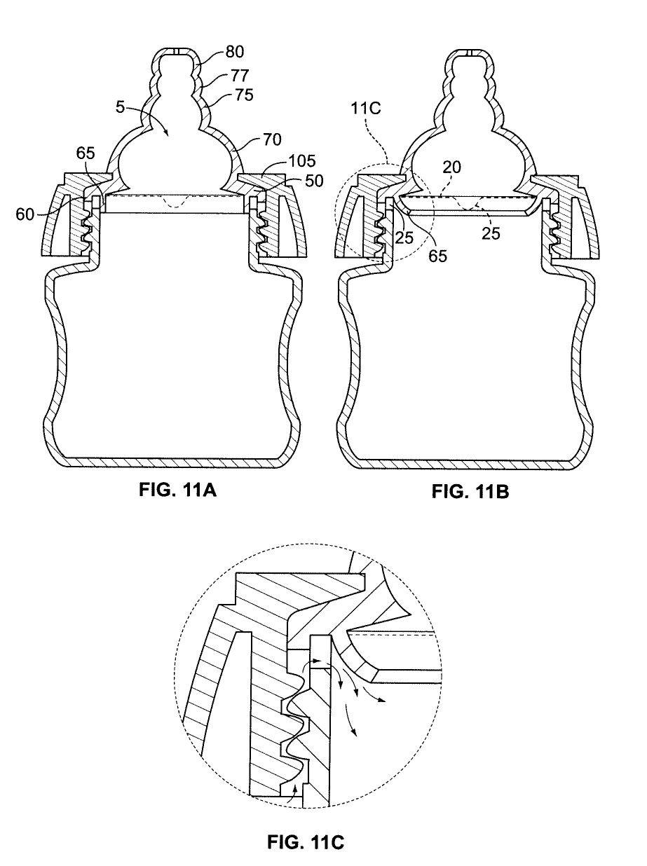

It is a further object of the present disclosure to provide a baby feeding system that accommodates the ever changing feeding needs of a child, from the time the child is born through the time the child is a toddler and able to drink out of a regular cup. Accordingly, referring to FIG. 10, the feeding system of the present disclosure comprises a plurality of baby bottle assemblies, including a bottle, feeding nipple, and neck ring as previously disclosed above, and a plurality of corresponding stages (e.g. Stage 1, Stage 2, etc.). Each stage has associated therewith a separate baby bottle assembly (a “staged baby bottle assembly”) that functions and is configured as previously disclosed herein. Each staged baby bottle assembly has different physical characteristics than the other staged bottle assemblies in the other stages of the feeding system. The separate stages and their associated staged baby bottle assemblies are configured to compliment the natural progression in the development, feeding ability, and strength of the child, as the child transitions from a newborn to a toddler.

As to the differing physical characteristics of the bottles at each stage, generally the bottle in each successive stage has a volume that is either equal to or greater than the volume of the bottle in the preceding stage. Referring to FIG. 10 for example, one embodiment of the feeding system comprises three separate stages (e.g. Stage 1, Stage 2, and Stage 3) with three staged bottle assemblies. In this embodiment, a first bottle 120 associated with Stage 1 has a first volume (e.g. 5 fl. oz.), a second bottle 125 associated with Stage 2 has a second volume (e.g. 9 fl. oz.) larger than the first volume of Stage 1, and a third bottle 130 associated with Stage 3 has a third volume (e.g. 9 fl. oz. or 11 fl. oz.) equal to or larger than the volume of the second bottle from Stage 2. The generally increasing bottle volumes at each new Stage correspond to the child's naturally increasing ability to ingest ever greater volumes of feeding fluids as the child increases in age and progresses through the natural stages of feeding.

In alternate embodiments, the bottles at each successive stage may have different volumes than those used as examples in the previous embodiment, with the bottle volumes generally increasing between the first stage and the last stage in the feeding system. For example, in yet another embodiment, the bottle volumes may be 5 fl. oz. in a Stage 1, 7 fl. oz. in a Stage 2, and 9 fl. oz. in a Stage 3.

Furthermore, each of the artificial feeding nipples in each successive stage has a different hardness/softness, flexibility, and length than that of the other feeding nipples in the other stages. Generally, at each successive stage, the nipple associated therewith is progressively harder, less flexible, and longer than the nipple in the preceding stage(s). The length of the nipple is increased at each successive stage to accommodate the growth in size of the baby's mouth as the baby increases in age. The flexibility of the nipple is decreased, and the hardness of the nipple material is increased, at each successive stage to account for the greater strength, experience, and feeding skill of the child, and the fact that the child does not usually need the benefits of the softer, more flexible, nipple as the child's skill and strength increase when progressing through the later feeding stages.

Thus in the embodiment of FIG. 10, for example, a first feeding nipple 135, which corresponds to Stage 1, is the softest, having a Shore-A Durometer of 30 for example, the most flexible, and the shortest of the feeding nipples. This first feeding nipple 135, is designed to compliment the relatively low strength and new feeding skills of a very young child, as with a newborn for example. A second feeding nipple 140, which corresponds to Stage 2 in an embodiment of the feeding system, is harder, having a Shore-A Durometer of 40 for example, less flexible, and longer than the first feeding nipple 135. This second feeding nipple 140, is designed to compliment the increased strength and feeding skills as the child gets older, as with an infant for example. A third feeding nipple 145, which corresponds to Stage 3 in an embodiment of the feeding system, is the hardest, having a Shore-A Durometer of 50 for example, the least flexible, and the longest of the three feeding nipples. This third feeding nipple 145, is designed to compliment the significantly increased strength and feeding skills of an even older child, as with a 6-month old baby for example, and aid in the transition to feeding out of sippy-cups or regular cups.

In alternate embodiments, the artificial feeding nipples at each stage may have different durometer hardness values than those of the previous embodiment. For example, the first 135, second 140, and third 145 feeding nipples corresponding to each of Stages 1, 2, and 3 may alternatively have Shore-A Durometers of 30, 35, and 40 respectively, or other such increasing hardness values, depending on the overall feeding nipple characteristics desired at each successive stage in the system.

In addition, each of the feeding orifices disposed in the artificial feeding nipple of each successive stage has a different sized orifice than that of the other feeding orifices associated with the other stages. Generally, at each successive stage, the size of the feeding orifice is progressively larger than the size of the orifice in the preceding stage. Thus in the embodiment of FIG. 10, a first feeding orifice 150 in the feeding nipple 135 associated with Stage 1 is the smallest feeding orifice in any of the Stages 1, 2, or 3. A second feeding orifice 155 in the feeding nipple 140 associated with Stage 2 is larger than that of Stage 1, and the third feeding orifice 160 in the feeding nipple 145 associated with Stage 3 is the largest of the three feeding orifices. As with the bottle volumes at each successive stage, the successively increasing feeding orifice size corresponds to an increased fluid flow rate and a child's naturally increasing strength and ability to ingest greater volumes of feeding fluids as the child increases in age and progresses to the next stage in the system.

While the previous embodiment of the feeding system disclosed three separate stages, the disclosure of this embodiment should not be read to limit the number of stages that can be present in the feeding system. Rather, in alternate embodiments the system may comprise two, three, four, or five or more stages, as desired or required. For example, in an alternate embodiment, the feeding system may comprise five separate stages as follows: Stage 1 is for use with newborns between the ages of 0 to 3 months old; Stage 2 is for use with infants between the ages of 3 to 6 months old; Stage 3 is for use with babies between the ages of 6 to 12 months old; Stage 4 is for use as a trainer with babies between 12 and 18 months old and may optionally swap out the traditional styled feeding nipple, which simulates the shape of the areola and nipple of a woman's breast, with a sippy-cup-styled feeding nipple having an identical sealing portion as disclosed herein; and Stage 5 is for use with toddlers aged 18 months and older, again utilizing a sippy-cup-styled feeding nipple. In this last exemplary embodiment, the feeding orifice for each of the nipples in Stages 1, 2, and 3 are circular cylindrical holes, while the feeding orifice in the sippy-cup-styled feeding nipples in Stages 4 and 5 are Y-shaped triple slit orifices.

In addition, the artificial feeding nipples and bottles of the various stages may be mixed and matched according to the individual feeding development rate, strength, and progress of each child, as no two children are likely to develop strength or skill at the same rate. Accordingly, a first artificial feeding nipple, which is normally used with a first bottle in Stage 1, may optionally be used with the second bottle of Stage 2 to increased the overall volume to be fed to the child, but not increase the flow rate. Alternatively, the first bottle of Stage 1 may be used with the second feeding nipple of Stage 2 to increase the flow rate of the liquid to be fed to the child, but not the overall volume to be fed to the child. In this manner, intermediate stages can be created as needed before proceeding to the next complete stage.

What is claimed is:

1. A baby bottle assembly for feeding a child comprising:
a bottle having a neck, and a mouth disposed at an end of said neck;
at least one air venting notch disposed in said mouth;
an artificial feeding nipple having a lower end and an upper end, wherein said artificial feeding nipple includes at least one feeding orifice disposed in said upper end and a sealing portion located at said lower end that is fastened to said mouth of said bottle, wherein said sealing portion forms a substantially liquid tight seal with said mouth of said bottle;
at least one, one-way air valve at the location of said air venting notch in said mouth of said bottle, wherein said at least one air valve is formed by the fastening of said artificial feeding nipple to said mouth of said bottle, and through which air may enter said bottle assembly when a pressure outside said bottle assembly is greater than a pressure inside said bottle assembly.

2. The baby bottle assembly of claim 1, further comprising a neck ring located over said artificial feeding nipple and secured onto said neck of said bottle, for fastening said sealing portion of said artificial feeding nipple to said mouth of said bottle.

3. The baby bottle assembly of claim 2, wherein said bottle neck and said neck ring are secured by a helical threaded connection, and wherein said threads on said neck ring are internal interrupted-threads that allow air to pass thereby and into said one way air valves when the air pressure outside said bottle assembly is greater than a pressure inside said bottle assembly.

4. The baby bottle assembly of claim 2, wherein said bottle neck and said neck ring are secured by a bayonet-type connection that allows air to pass between said neck and said neck ring and into said one way air valves when the air pressure outside said bottle assembly is greater than a pressure inside said bottle assembly.

5. The baby bottle assembly of claim 1, wherein said sealing portion of said artificial feeding nipple comprises an outer skirt, a gasket, and a sealing ring, wherein when said artificial feeding nipple and bottle are fastened together, said outer skirt is seated around an outer surface of said bottle neck, said gasket forms a seal against said mouth of said bottle, and said sealing ring is seated against an inner surface of said bottle neck and completely covers said at least one air venting notch in said bottle mouth, so as to prevent liquid from leaking out of said bottle assembly.

6. The baby bottle assembly of claim 5, wherein said artificial feeding nipple further includes a hollow domed base connected to, and extending upward from, said sealing portion at said domed base's largest diameter, a hollow areola region connected to said domed base, a nipple-base connected to said areola region, and a nipple-tip connected to said nipple-base, wherein said feeding orifice is disposed in said nipple-tip to allow fluid to flow therethrough upon feeding by a child.

7. The baby bottle assembly of claim 1, wherein said bottle includes successive markings thereon for determining the volume of liquid contained in said bottle.

8. The baby bottle assembly of claim 1 further comprising a bottle cap that is removably secured to said neck ring, such that said cap covers said artificial feeding nipple to prevent contaminants from reaching said nipple.

9. A feeding system comprising a plurality of baby bottle assemblies according to claim 1 and a plurality of stages, wherein each baby bottle assembly is associated with a separate stage, and wherein each baby bottle assembly for each stage in the feeding system has different physical characteristics than the other baby bottle assemblies at each of the other stages in the system, and wherein each stage and baby bottle assembly combination corresponds to a different stage in the feeding development of the child.

10. The feeding system of claim 9, wherein at each successive stage in said system, said bottle from said baby bottle assembly has an equal or greater volume than a bottle from said baby bottle assembly in said previous stage of said system, and wherein said bottles' volumes correspond to a natural progression in said child's ability to ingest greater volumes of fluid as said child progresses from one developmental feeding stage to the next.

11. The feeding system of claim 9, wherein at each successive stage in said system, said artificial feeding nipple in said baby bottle assembly is longer and less flexible than an artificial feeding nipple in said baby bottle assembly of said previous stage of said system, and wherein said artificial feeding nipples' lengths and flexibilities correspond to a natural progression in said child's ability to nurse more effectively as said child gets older.

12. The feeding system of claim 9, wherein at each successive stage in said system, said feeding orifice in said baby bottle assembly is larger than a feeding orifice in said baby bottle assembly in said previous stage of said system, and wherein said artificial feeding nipples' orifice sizes correspond to a natural progression in said child's ability to ingest greater volumes of fluid as said child progresses from one developmental feeding stage to the next.

13. The feeding system of claim 9, wherein said feeding system comprises three stages and three corresponding baby bottle assemblies.

14. The feeding system of claim 9, wherein said feeding system comprises four stages and four corresponding baby bottle assemblies.

15. The feeding system of claim 9, wherein said feeding system comprises five stages and five corresponding baby bottle assemblies.
